(19) United States
(12) Patent Application Publication
(10) Pub. No.: US 2026/0066574 A1
(43) Pub. Date: Mar. 5, 2026

(54) CONNECTOR

(71) Applicant: P-TWO INDUSTRIES INC., Taoyuan City (TW)

(72) Inventors: Jeng-Yi You, Taoyuan City (TW); Chih-Wei Huang, Taoyuan City (TW)

(21) Appl. No.: 19/250,836

(22) Filed: Jun. 26, 2025

(30) Foreign Application Priority Data
Aug. 28, 2024 (TW) 113132350

(51) Int. Cl. H01R 13/52

(52) U.S. Cl. CPC H01R 13/5202

(57) ABSTRACT

The connector is used for connecting with a mating connector. The connector includes a first housing, a second housing, a third housing, a first contact module, and a second contact module. The first housing includes a first main portion and a second main portion. The second main portion further comprises an adjacent first surface and a second surface, and the first surface and the second surface form a height difference, thereby defining a recessed area between the first main portion and the second main portion. The second housing includes a second housing body and two extension arms. The third housing includes a third housing body, two first central tubes, and two second central tubes. The first contact module and the second contact module are disposed in the third housing. When the first housing engages with a spacer, the connector can be securely mated with the mating connector.

### CROSS-REFERENCES TO RELATED APPLICATIONS

This application claims the benefit of Taiwan Patent Application Serial No. 113132350 filed on Aug. 28, 2024, the subject matter of which is incorporated herein by reference

### BACKGROUND OF THE INVENTION

### Field of the Invention

The present invention relates to a connector, particularly an automotive connector featuring a recessed area and a sealing member for segmented waterproofing.

### Descriptions of the Related Art

H-MTD connectors are widely used in automotive electronics and industrial automation for high-speed data transmission. With the growing demand for faster and more reliable data transfer in vehicles, the need for H-MTD connectors in automotive Ethernet interfaces is also increasing. Since automotive environments often involve exposure to moisture, mud, and other harsh conditions, reliable waterproofing is essential to maintain performance and extend the connector's lifespan.

Currently, the waterproofing of H-MTD connectors primarily relies on waterproof adhesive. The waterproof adhesive forms a reliable barrier at the connector interface, preventing moisture from entering and protecting internal electronic components, ensuring stable operation even in humid environments. For example, Chinese Patent No. CN218770423U discloses an electrical connector that achieves waterproofing with the spacer by coating adhesive on the smooth surface of the core. However, this adhesive coating method is limited by the uniformity of the application. Excessive coating may interfere with other components of the connector, while insufficient coating may compromise the sealing effectiveness with the spacer. As a result, this is not an ideal waterproofing solution.

In view of the above, the present invention provides a connector to overcome the insufficient waterproof performance of the conventional connectors and the associated issues.

### SUMMARY OF THE INVENTION

The objective of the present invention is to provide a connector that includes a first housing, a second housing, a third housing, a first contact module, and a second contact module assembled together. The main feature is that the first housing has a first surface and a second surface with height differences for forming a recessed area. Additionally, a sealing member is disposed on the first housing at the recessed area. The sealing member has protruding ribs that securely engage the spacer components with the connector. This combination of the recessed area and sealing member allows the spacer to be tightly fixed to the first housing, achieving waterproof performance without requiring any waterproof adhesive. The design of multiple protruding ribs also provides the additional benefit of segmented waterproofing.

To achieve the above-mentioned objective, the present invention discloses a connector is used for connecting with a mating connector. The connector comprises a first housing, a second housing, a third housing, a first contact module, and a second contact module. The first housing comprises a first main portion and a second main portion connected to the first main portion. The second main portion further includes a first surface and a second surface adjacent to the first surface. The first surface and the second surface form a height difference, thereby jointly defining a recessed area between the first main portion and the second main portion. The second housing comprises a second housing body and two extension arms. The extension arms are respectively formed on opposite sides of the second housing body along a first direction. The third housing is disposed between the first housing and the second housing. The third housing comprises a third housing body, two first central tubes, and two second central tubes. The first central tubes and the second central tubes are respectively formed on one side of the third housing body along the first direction. The first contact module is disposed in the third housing. The first contact module comprises two first inner housing elements and two pairs of first contact elements. Each pair of the first contact elements inserts into one of the first inner housing elements, respectively. The second contact module is disposed in the third housing. The second contact module comprises two second inner housing elements and two pairs of second contact elements. Each pair of the second contact elements inserts into one of the second inner housing elements, respectively. The first main portion and the second main portion jointly define a first accommodating space, for receiving portions of the third housing, the first contact module, and the second contact module. The second housing and the third housing jointly define a second accommodating space, for receiving other portions of the first contact module and the second contact module. When the first housing engages with a spacer, the connector is securely mated with the mating connector.

In one embodiment of the present invention, the connector further comprises a sealing member disposed in the recessed area and firmly contacting with the first surface.

In one embodiment of the present invention, the sealing member further comprises a plurality of protruding ribs circumferentially formed on an outer surface of the sealing member and tightly contacting with the spacer.

In one embodiment of the present invention, the first main portion further comprises an extension section extending along a second direction from the first main portion such that the sealing member and the spacer are abutted with each other and are fixed to the first housing.

In one embodiment of the present invention, the second main portion further comprises two first holes and two second holes arranged in a vertical alignment. The first holes are configured to accommodate the first central tubes. The second holes are configured to accommodate the second central tubes.

In one embodiment of the present invention, each of the first central tubes further comprises a first through slot. Each of the second central tubes further comprises a second through slot. Each of the first inner housing elements is partially inserted into the first through slot. Each of the second inner housing elements is partially inserted into the second through slot.

In one embodiment of the present invention, the first housing further comprises at least one positioning member and a plurality of abutting members. The third housing further comprises at least one positioning slot. When the first housing, the second housing, and the third housing are connected, the at least one positioning member correspondingly engages with the at least one positioning slot, and the abutting members abut against the third housing body.

In one embodiment of the present invention, the second housing further comprises two first protrusions respectively formed on inner side surfaces of the extension arms. The third housing further comprises two second protrusions respectively formed on opposite side surfaces of the third housing body. When the second housing is connected to the third housing, the first protrusions abut against the second protrusions.

In one embodiment of the present invention, the connector further comprises an intermediate element inserted into the third housing body to block electromagnetic interference between the first contact module and the second contact module.

In one embodiment of the present invention, the first housing further comprises a plurality of grooves and a plurality of engaging members for accommodating the mating connector.

The detailed technology and preferred embodiments of the present invention are described in the following paragraphs, accompanied by the appended drawings, to enable those skilled in the art to fully understand the objectives, technical methods, and embodiments of the claimed invention.

### BRIEF DESCRIPTION OF THE DRAWINGS

FIG. 1 is a schematic view of the assembly of the connector, circuit board, spacer, and mating connector according to one embodiment of the present invention;

FIG. 2 is a schematic view of the assembly of the connector and circuit board according to one embodiment of the present invention;

FIG. 3 is an exploded view of the connector according to one embodiment of the present invention;

FIG. 4 is another perspective exploded view of the connector according to one embodiment of the present invention;

FIG. 5 is a side cross-sectional view of the connector, circuit board, and spacer according to one embodiment of the present invention;

FIG. 6 is a side cross-sectional view of the connector and circuit board according to one embodiment of the present invention;

FIG. 7 is a top view of the connector according to one embodiment of the present invention;

### FIG. 8 Is a Schematic View of the Connector According to One Embodiment of the present invention;

### FIG. 9 is a side view of the first housing according to one embodiment of the present invention;

FIG. 10 is a schematic view of the mating arrangement of the connector according to one embodiment of the present invention; and

FIG. 11 is a side cross-sectional view of the assembly of the third housing, first contact module, and second contact module according to one embodiment of the present invention.

### DETAILED DESCRIPTION OF THE PREFERRED EMBODIMENT

Reference will now be made in detail to the present embodiments of the invention, examples of which are illustrated in the accompanying drawings, and are not intended to limit the present invention, applications or particular implementations described in these embodiments. Wherever possible, the same reference numbers are used in the drawings and the description to refer to the same or like parts. It shall be appreciated that, in the following embodiments and the attached drawings, elements unrelated to the present invention are omitted from depiction; and dimensional relationships among individual elements in the attached drawings are provided only for ease of understanding, but not to limit the actual scale.

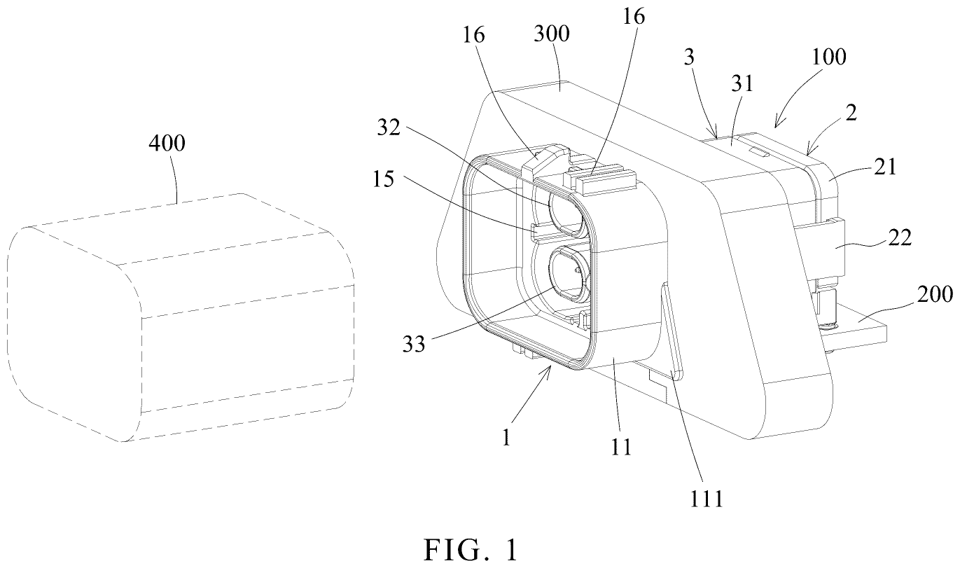

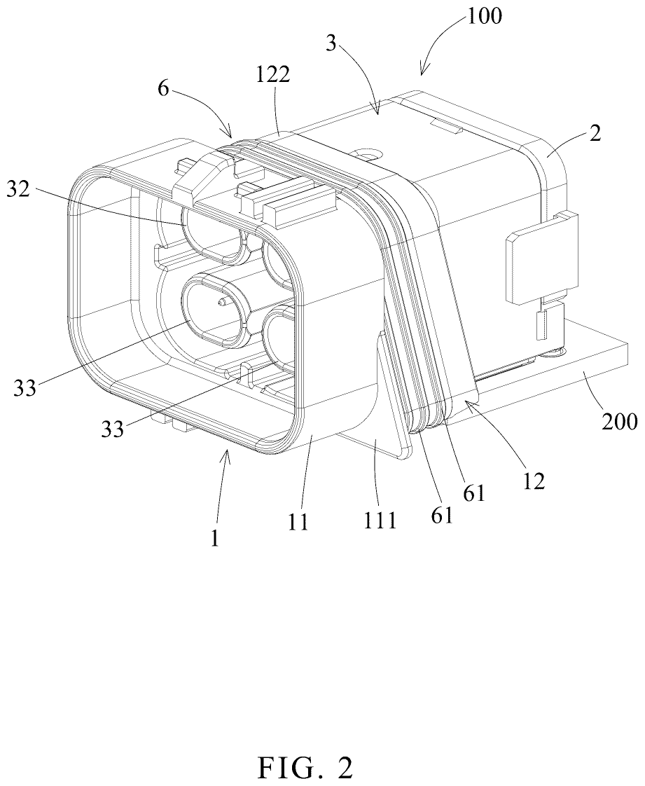

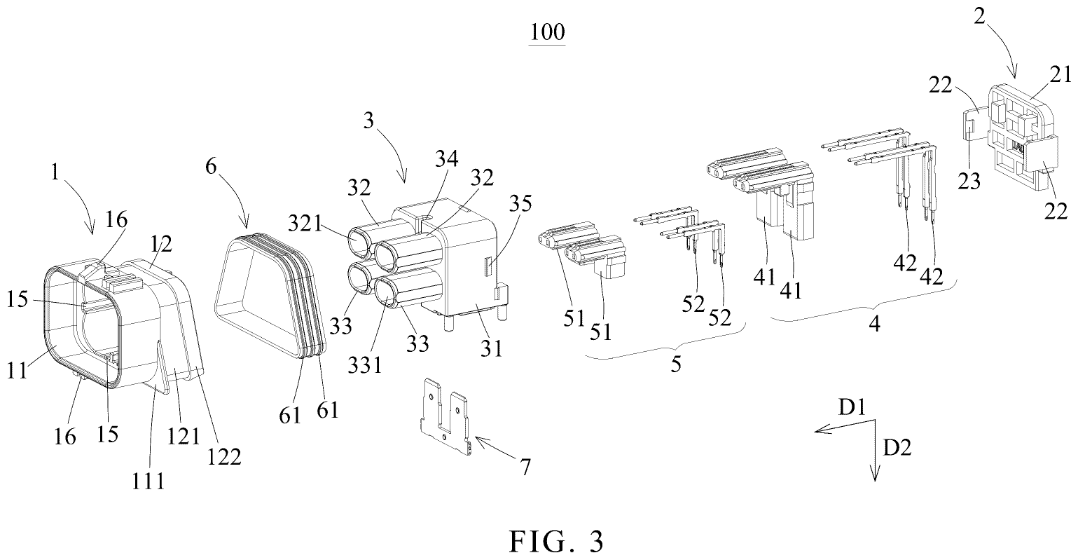

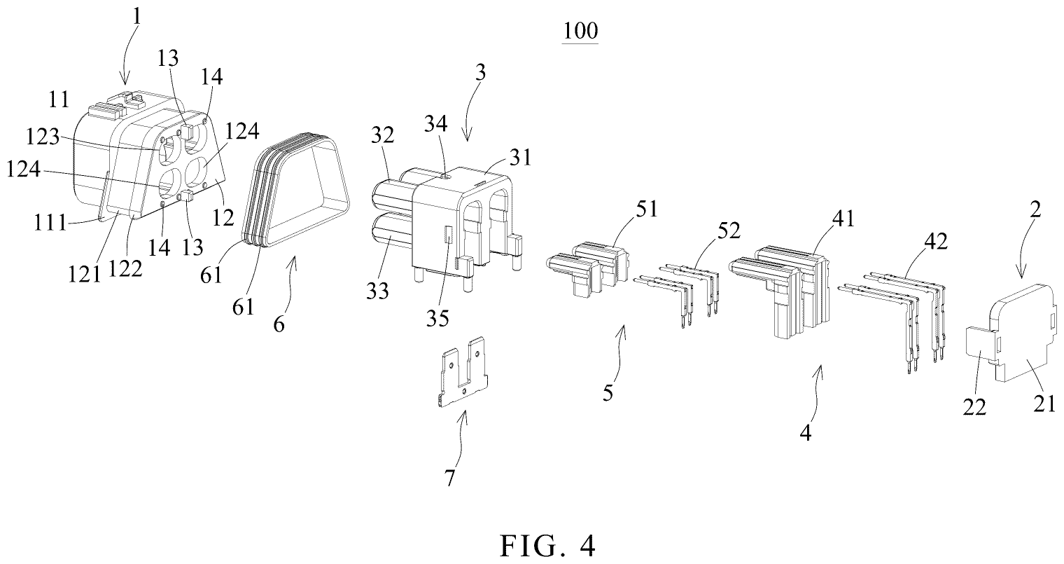

Please refer to FIG. 1 to FIG. 4. FIG. 1 is a schematic view showing the assembly relationship between the connector 100, the circuit board 200, the spacer 300, and the mating connector 400 according to one embodiment of the present invention. FIG. 2 is a schematic view of the assembly between the connector 100 and the circuit board 200 according to one embodiment of the present invention. FIG. 3 and FIG. 4 are exploded views of the connector 100 from different perspectives. The connector 100 is disposed on the circuit board 200, with the spacer 300 also disposed on the connector 100. The connector 100 can engage with the mating connector 400, as shown in FIG. 1. The connector 100 of the present invention includes a first housing 1, a second housing 2, a third housing 3, a first contact module 4, a second contact module 5, a sealing member 6, and an intermediate element 7. Specifically, the first housing 1 and the second housing 2 are located on the front and rear sides of the connector 100, respectively. The third housing 3 is disposed between the first housing 1 and the second housing 2. In other words, the first housing 1, second housing 2, and third housing 3 engage with each other. The third housing 3 accommodates the first contact module 4 and the second contact module 5. The sealing member 6 is mounted on the first housing 1. The intermediate element 7 is inserted into the third housing 3 and positioned between the first contact modules 4 and the second contact modules 5. For example, when the first housing 1 engages with the spacer 300, the connector 100 can securely mate with the mating connector 400. In this embodiment, the spacer 300 is disposed on the connector 100 and serves as a connecting medium for use in various environments. In other words, the spacer 300 can be used for installing the connector 100 in different areas of a vehicle, with its appearance for illustration and not limited thereto.

Next, please refer to FIG. 8 and FIG. 9 for an illustration of the first housing 1. FIG. 8 is a schematic view of the connector 100 according to one embodiment of the present invention. FIG. 9 is a side view of the first housing 1 in one embodiment of the present invention. The first housing 1 includes a first main portion 11, a second main portion 12, two positioning members 13, a plurality of abutting members 14, a plurality of grooves 15, and a plurality of engaging members 16. The first main portion 11 and the second main portion 12 are connected to each other. The positioning members 13 and the abutting members 14 are arranged on one side of the second main portion 12, near the connection between the first housing 1 and the third housing 3. When the first housing 1 is engaged with the third housing 3, they function to position and restrict movement. The grooves 15 are formed on the inner side surface of the first main portion 11. The engaging members 16 are arranged on the upper and lower side surfaces of the first main portion 11. The grooves 15 and the engaging members 16 facilitate mating connections with the mating connector 400 and improve the accuracy of the connector 100 during mating. On the other hand, the first main portion 11 and the second main portion 12 jointly define a first accommodating space S1, which partially accommodates the third housing 3, the first contact module 4, and the second contact module 5, as shown in FIG. 8. It should be noted that in this embodiment, the number of abutting members 14 is exemplified as eight, but the quantity and position can be adjusted based on actual connection requirements and are not limited thereto.

In addition, the first main portion 11 further includes an extension section 111, which extends along a second direction D2 from the first main portion 11. The extension section 111 is formed in a trapezoidal shape, extending from the left and right sides and the lower side of the first main portion 11 near the second main portion 12, along the second direction D2. This arrangement enables the sealing member 6 and the spacer 300 to be abutted against and fixed onto the first housing 1. It should be noted that in this embodiment, the extension section 111 is exemplified as a single piece, the quantity and position may be adjusted according to actual needs, and not limited thereto. On the other hand, the second main portion 12 includes a first surface 121, a second surface 122, two first holes 123, and two second holes 124. The first surface 121 and the second surface 122 are adjacent and surround the outer side of the second main portion 12. The first surface 121 and the second surface 122 are positioned on different planes, creating a height difference, with the first surface 121 at a lower plane and the second surface 122 at a higher plane. The height difference defines a recessed area R formed between the first surface 121 of the first main portion 11 and the second surface 122 of the second main portion 12. The recessed area R surrounds the first surface 121 and is configured to accommodate the sealing member 6. Furthermore, the first holes 123 and the second holes 124 are formed on the side of the second main portion 12, near the connection between the first housing 1 and the third housing 3. The first holes 123 and the second holes 124 are arranged in a vertical alignment. The first holes 123 are positioned on the upper row to accommodate part of the third housing 3. The second holes 124 are positioned on the lower row to accommodate another part of the third housing 3.

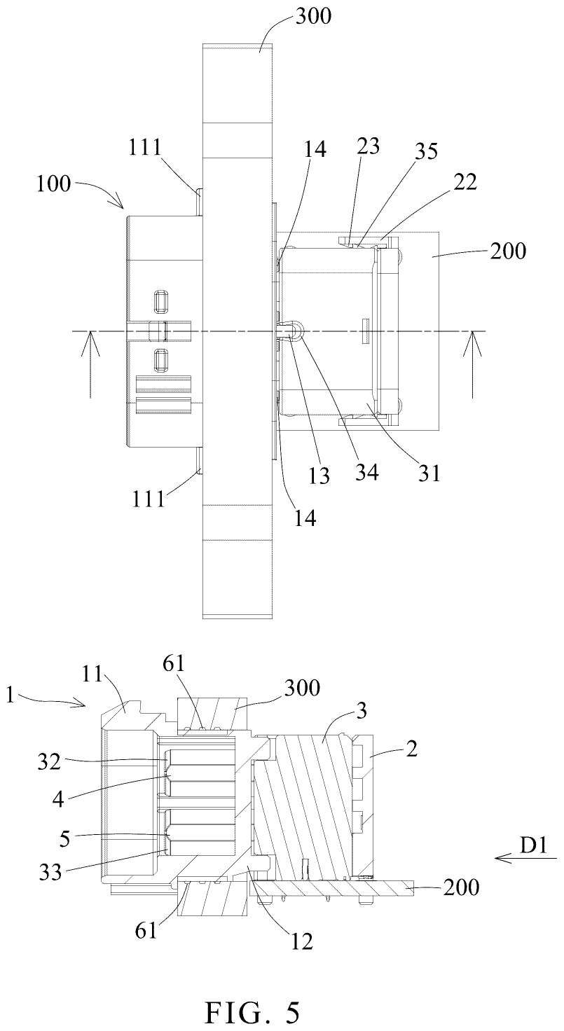

The following provides a detailed description of the second housing 2 and the third housing 3 of the present invention. Please refer to FIGS. 5 to 7, FIG. 10, and FIG. 11. The second housing 2 includes a second housing body 21, two extension arms 22, and two first protrusions 23. The extension arms 22 are formed along a first direction D1 on the left and right sides of the second housing body 21, respectively. The first protrusions 23 are respectively formed on the inner surfaces of the extension arms 22. The diameter of the first protrusions 23 gradually decreases along the first direction D1, presenting an oblique triangular protrusion structure, which is used to facilitate the engagement between the second housing 2 and the third housing 3.

The third housing 3 includes a third housing body 31, two first central tubes 32, two second central tubes 33, two positioning slots 34, and two second protrusions 35. The first central tubes 32 and the second central tubes 33 are respectively formed on one side of the third housing body 31 along the first direction D1, as shown in FIG. 11. Specifically, each of the first central tubes 32 includes a first through slot 321. Each of the second central tubes 33 includes a second through slot 331. The first contact module 4 is partially inserted into the first through slot 321, and the second contact module 5 is partially inserted into the second through slot 331. Additionally, the positioning slots 34 are formed on one side of the third housing body 31, near the first housing 1. The second protrusions 35 are formed on the opposite outer sides of the third housing body 31, near the second housing 2. The diameter of each second protrusion 35 gradually increases along the first direction D1, presenting an oblique triangular protrusion structure. The positioning slots 34 correspond to the positioning members 13 of the first housing 1. The second protrusions 35 correspond to the first protrusions 23 of the second housing 2. When the first housing 1, second housing 2, and third housing 3 are interconnected, the positioning members 13 of the first housing 1 engages with the positioning slots 34, and the abutting members 14 abuts against one side of the third housing body 31. On the other hand, when the second housing 2 is connected to the third housing 3, the first protrusions 23 move through the second protrusions 35. The longest edge of the first protrusions 23 abuts and interlocks with the longest edge of the second protrusions 35, ensuring a secure connection between the second housing 2 and the third housing 3. It should be noted that, in this embodiment, the combination of the positioning member 13 with the positioning slot 34 and the combination of the first protrusion 23 with the second protrusion 35 are each exemplified as two sets. The quantity and position may be adjusted according to actual connection requirements and are not limited thereto.

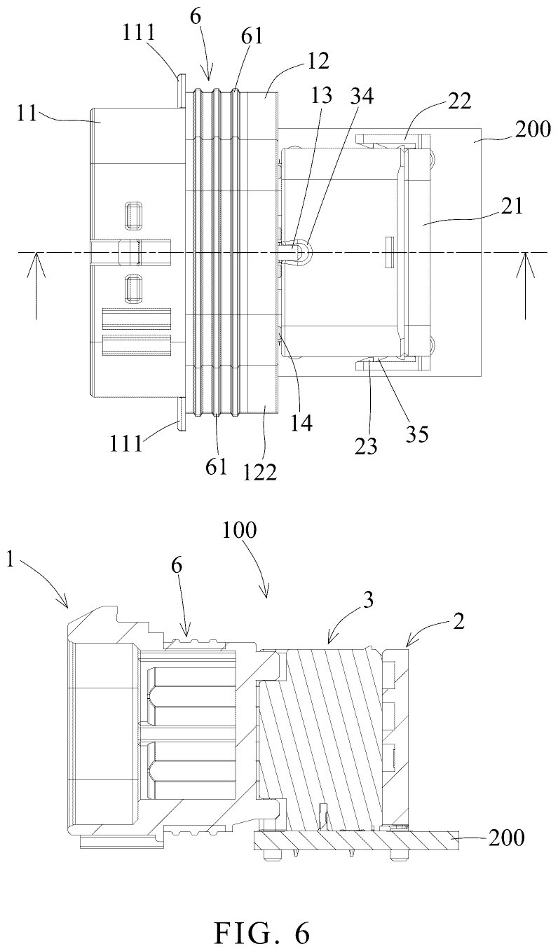

Reference is next made to FIG. 5, FIG. 6, and FIG. 11 for illustrating the first contact module 4 and the second contact module 5. The first contact module 4 and the second contact module 5 are arranged in the third housing 3. The first contact module 4 comprises two first inner housing elements 41 and two pairs of first contact elements 42. Each pair of the first contact elements 42 is inserted into the first inner housing element 41, respectively. The second contact module 5 comprises two second inner housing elements 51 and two pairs of second contact elements 52. Each pair of the second contact elements 52 is inserted into the second inner housing element 51, respectively. Specifically, the first inner housing elements 41 and the first contact elements 42 are partially inserted into the first through slots 321 of the first central tubes 32. The second inner housing elements 51 and the second contact elements 52 are partially inserted into the second through slots 331 of the second central tubes 33. In this embodiment, the first inner housing elements 41, first contact elements 42, second inner housing elements 51, and second contact elements 52 generally form an L-shape. Each pair of the first contact elements 42 and each pair of the two second contact elements 52 consist of two conductive terminals, with one end electrically connected to the terminals of the mating connector 400 and the other end electrically connected to the circuit board 200. It should be noted that in this embodiment, the first inner housing element 41 and the second inner housing element 51 are each exemplified as two pieces, while the first contact element 42 and second contact element 52 are each exemplified as four pieces. The quantities can be adjusted based on actual needs and are not limited thereto.

In this embodiment, when the first housing 1, the second housing 2, and the third housing 3 are engaged with each other, portions of the third housing 3, the first contact module 4, and the second contact module 5 are disposed within the first accommodating space S1. On the other hand, the second housing 2 and the third housing 3 jointly define a second accommodating space S2, in which other portions of the first contact module 4 and the second contact module 5 are disposed. This configuration allows the second housing 2 to tightly engage with the third housing 3, thereby sealing the second accommodating space S2 to prevent the first contact elements 42 and the second contact elements 52 from coming into contact with or being interfered with by other connectors.

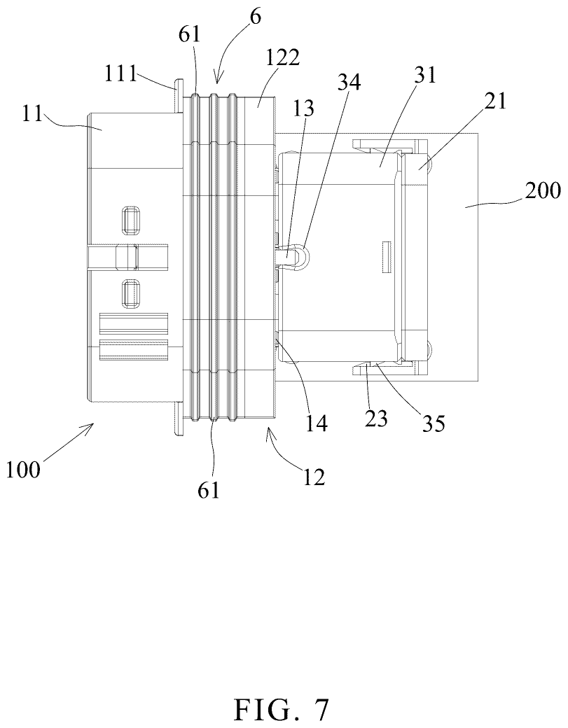

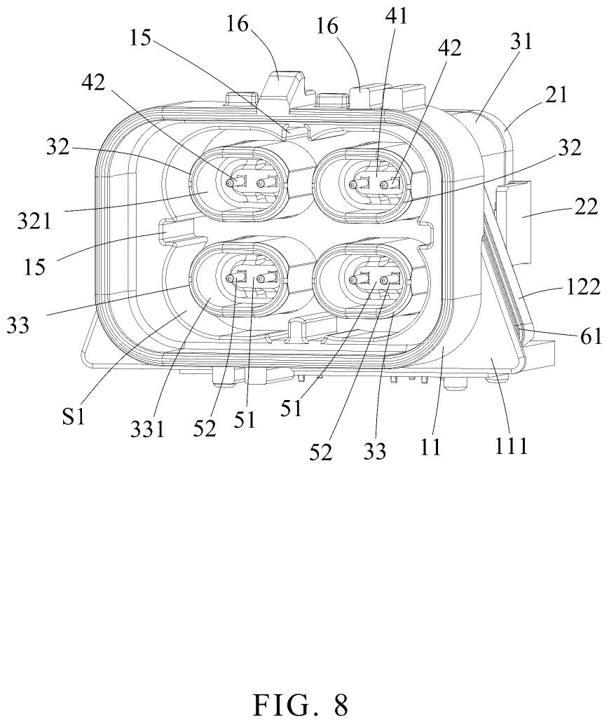

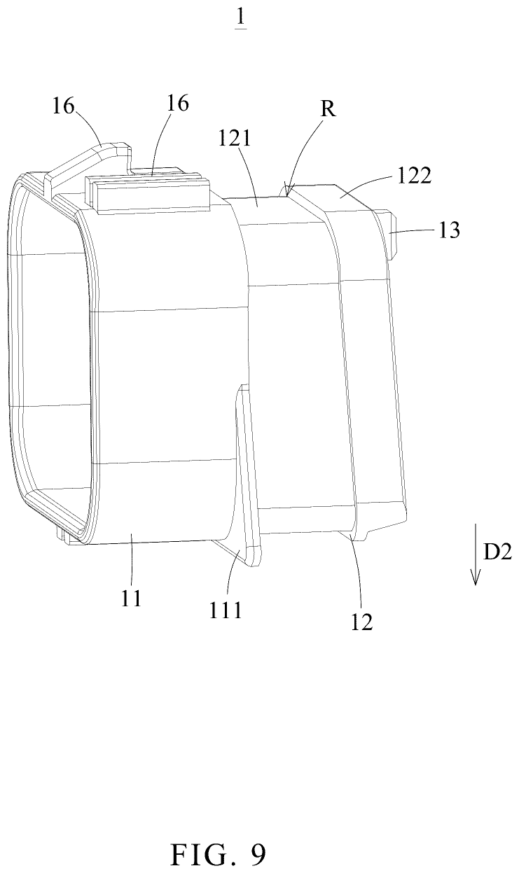

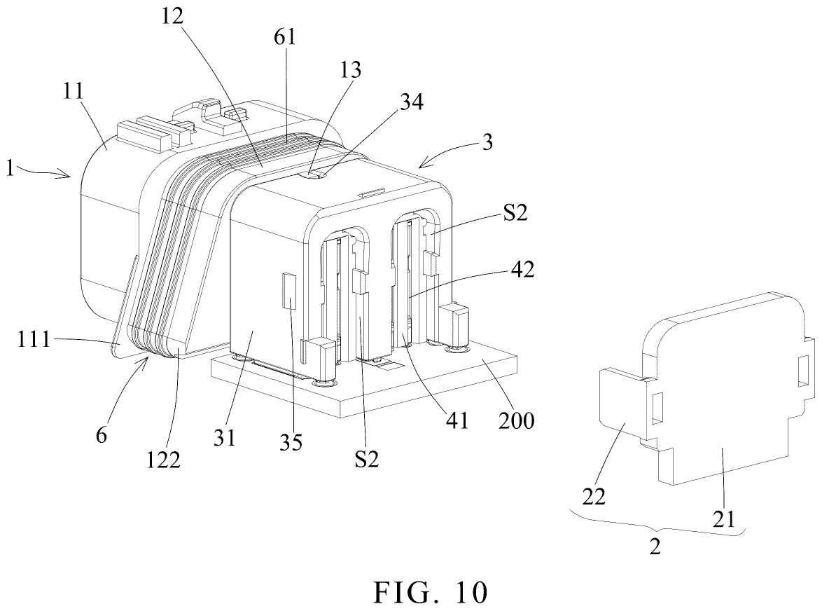

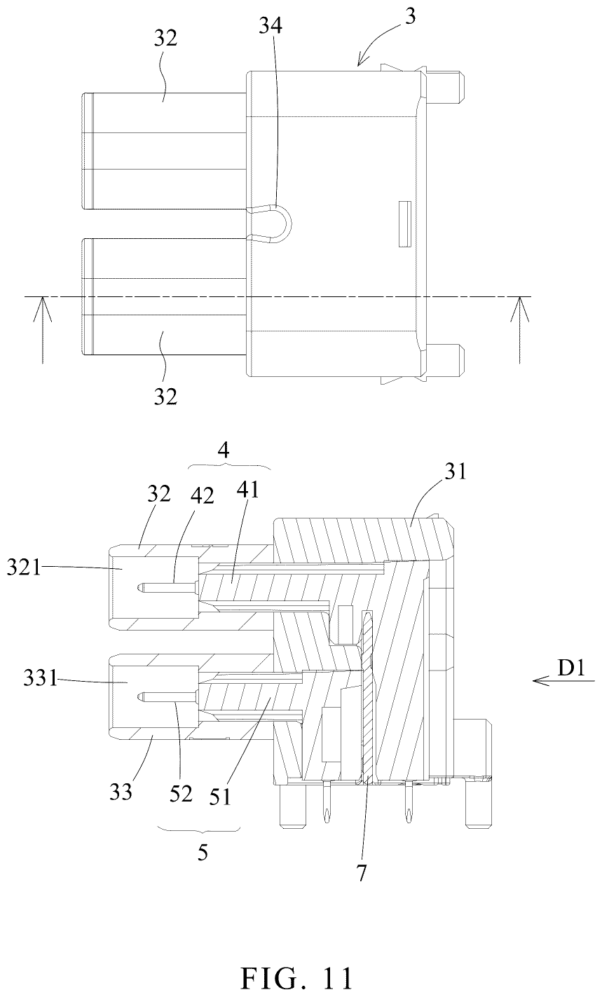

Please refer to FIG. 1, FIG. 2, FIG. 6, and FIG. 7. The shape of the sealing member 6 is complementary to the recessed area R. The sealing member 6 is sleeved in the recessed area R and firmly contacts with the first surface 121 of the second main body 12. The sealing member 6 includes a structure with three protruding ribs 61, which are arranged in parallel and form a circumferential arrangement on the outer side of the sealing member 6. The protruding ribs 61 have an arcuate shape, and their height is slightly higher than the second surface 122 when compared in the same plane. When the sealing member 6 tightly interferes with the spacer 300, the outer surface of the sealing member 6 and the arcuate surface of the protruding ribs 61 form the sealing interface between the sealing member 6 and the spacer 300. Each protruding rib 61 functions as segmented waterproofing. Specifically, in this embodiment, the sealing member 6 can be made of rubber material, ensuring a sealed connection between the first housing 1 of the connector 100 and the spacer 300, effectively preventing moisture, dust, and other debris from entering the connector 100.

Please refer again to FIG. 11. The intermediate element 7 is inserted into the third housing body 31 and clamped between the first contact module 4 and the second contact module 5, serving to prevent electromagnetic interference between the first contact elements 42 and the second contact elements 52.

Furthermore, as shown in FIG. 8, in this embodiment, the first central tubes 32 and the second central tubes 33 have elliptical shapes, and the first inner housing element 41 and the second inner housing element 51 are designed to match these shapes with elliptical shapes. Similarly, the first through holes 123 and the second through holes 124 are also designed with elliptical shapes. It should be noted that the quantity and shape of the central tubes, inner housing elements, and through holes can be adjusted according to actual connection requirements, such as circular or rectangular polygonal designs, and are not limited thereto.

In summary, the connector of the present invention comprises a first housing, a second housing, and a third housing, which are interlocked to accommodate and protect internal components such as the first contact module, the second contact module, and the intermediate element. The first housing features a first surface and a second surface with a height difference, which joint define a recessed area. The flexible sealing member firmly disposed at the recessed area, and the protruding ribs on the sealing member form a tight seal between the spacer and the connector. Based on this, the connector of the present invention incorporates a recessed area and a sealing member, along with a plurality of protruding ribs on the sealing member. These elements work together to function as segmented waterproofing when the connector, connected to the spacer, is engaged with a mating connector. Additionally, the intermediate element helps to prevent electromagnetic interference.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A connector for connecting with a mating connector, the connector comprising:
a first housing comprising a first main portion and a second main portion connected to the first main portion, wherein the second main portion further includes a first surface and a second surface adjacent to the first surface, and the first surface and the second surface form a height difference, thereby jointly defining a recessed area between the first main portion and the second main portion;
a second housing comprising a second housing body and two extension arms, wherein the extension arms are respectively formed on opposite sides of the second housing body along a first direction;
a third housing disposed between the first housing and the second housing, the third housing comprising a third housing body, two first central tubes, and two second central tubes, wherein the first central tubes and the second central tubes are respectively formed on one side of the third housing body along the first direction;
a first contact module disposed in the third housing, the first contact module comprising two first inner housing elements and two pairs of first contact elements, wherein each pair of the first contact elements inserts into one of the first inner housing elements, respectively; and
a second contact module disposed in the third housing, the second contact module comprising two second inner housing elements and two pairs of second contact elements, wherein each pair the of second contact elements inserts into one of the second inner housing elements, respectively;
wherein the first main portion and the second main portion jointly define a first accommodating space for receiving portions of the third housing, the first contact module, and the second contact module, and the second housing and the third housing jointly define a second accommodating space for receiving other portions of the first contact module and the second contact module, and when the first housing engages with a spacer, the connector is securely mated with the mating connector.

2. The connector of claim 1, further comprising a sealing member disposed in the recessed area and firmly contacting the first surface.

3. The connector of claim 2, wherein the sealing member further comprises a plurality of protruding ribs circumferentially formed on an outer surface of the sealing member and tightly contacting with the spacer.

4. The connector of claim 2, wherein the first main portion further comprises an extension section extending along a second direction from the first main portion such that the sealing member and the spacer are abutted with each other and are fixed to the first housing.

5. The connector of claim 1, wherein the second main portion further comprises two first holes and two second holes arranged in a vertical alignment, the first holes are configured to accommodate the first central tubes, and the second holes are configured to accommodate the second central tubes.

6. The connector of claim 1, wherein each of the first central tubes further comprises a first through slot, and each of the second central tubes further comprises a second through slot, and wherein each of the first inner housing elements is partially inserted into the first through slot, and each of the second inner housing elements is partially inserted into the second through slot.

7. The connector of claim 1, wherein the first housing further comprises at least one positioning member and a plurality of abutting members, the third housing further comprises at least one positioning slot, and when the first housing, the second housing, and the third housing are connected, the at least one positioning member correspondingly engages with the at least one positioning slot, and the abutting members abut against the third housing body.

8. The connector of claim 1, wherein the second housing further comprises two first protrusions respectively formed on inner side surfaces of the extension arms, and the third housing further comprises two second protrusions respectively formed on opposite side surfaces of the third housing body, and when the second housing is connected to the third housing, the first protrusions abut against the second protrusions.

9. The connector of claim 1, further comprising an intermediate element inserted into the third housing body to block electromagnetic interference between the first contact module and the second contact module.

10. The connector of claim 1, wherein the first housing further comprises a plurality of grooves and a plurality of engaging members for accommodating the mating connector.
